(19) United States
(12) Patent Application Publication
(10) Pub. No.: US 2017/0016251 A1
(43) Pub. Date: Jan. 19, 2017

(54) Driving device of electronic lock

(71) Applicant: Chun-Han FAN, Xingang Township (TW)

(72) Inventor: Chun-Han FAN, Xingang Township (TW)

(21) Appl. No.: 14/797,193

(22) Filed: Jul. 13, 2015

(51) Int. Cl. E05B 47/00

(52) U.S. Cl. CPC E05B 47/0012; E05B 2047/002

(57) ABSTRACT

A driving device of an electronic lock contains: a base, a power assembly, a gear disc, a rotary knob, and a rotation disc. The base includes a through orifice defined thereon to insert the rotary knob and includes an accommodation chamber formed therein to accommodate the power assembly. The power assembly supplies a power source to rotate the gear disc. The gear disc includes a through hole defined on a central position thereof and corresponding to the through orifice. The rotary knob includes a first segment and a second segment which inserts through the through orifice and the through hole. The rotation disc is fitted with the second segment of the rotary knob. The gear disc also includes a protruded stem adjacent to the through hole, and the rotary knob also includes a driving block arranged on the second segment thereof and corresponding to the protruded stem.

### FIELD OF THE INVENTION

The present invention relates to a driving device of an electronic lock which opens and closes the electronic lock easily and stably.

### BACKGROUND OF THE INVENTION

A conventional electronic lock is mounted on a door to open and close the door. For example, after a rotary knob of the electronic lock is rotated, it drives a gear of a power assembly and a lock latch. However, such an electronic lock is complicated and its service life is reduced.

Reference to FIGS. 1 and 2, another conventional electronic lock is mounted on a door 3 which has an inner wall 31, an outer wall 32, and a connection face 33 defined between the inner wall 31 and the outer wall 32. The electronic lock contains a locking mechanism 4, a base 5, a manual controlling mechanism 6, an electronic controlling mechanism 7, a power mechanism 8, and two clutch limitation mechanisms 9.

The locking mechanism 4 is fixed in the door 3 and has a lock latch 41 extending outwardly from the connection face 33 to lock or unlock the door 3. The base 5 is disposed on the inner wall 31 of the door 3 and has a side plate 51 parallel to the inner wall 31, a peripheral fence 52 perpendicularly extending to the inner wall 31 from the side plate 51, and an accommodation chamber 53 defined by the side plate 51 and the peripheral fence 52. The side plate 51 has a through orifice 511 defined thereon, and each clutch limitation mechanism 9 is defined between a limiting piece 82 and a rotary disc 62 and has a positioning ball 91 fixed in a receiving orifice 624, a spring 92, a first recessed rim 93 formed on the limiting piece 82, and a second recessed rim 94. In assembly, the positioning ball 91 extends out of the rotary disc 62 and into the first recessed rim 93 of the limiting piece 82. However, an elasticity of the spring 92 of each clutch limiting mechanism 9 influences a locking and an unlocking of the door. In other words, this conventional electronic lock cannot open and close the door stably.

The present invention has arisen to mitigate and/or obviate the afore-described disadvantages.

### SUMMARY OF THE INVENTION

The primary object of the present invention is to provide a driving device of an electronic lock which opens and closes the electronic lock easily and stably.

To obtain the above objective, a driving device of an electronic lock provided by the present invention contains: a base, a power assembly, a gear disc, a rotary knob, and a rotation disc.

The base is a casing and includes a through orifice defined thereon to insert the rotary knob, and the base also includes an accommodation chamber formed therein to accommodate the power assembly.

The power assembly supplies a power source to rotate the gear disc.

The gear disc includes a through hole defined on a central position thereof and corresponding to the through orifice of the base.

The rotary knob includes a first segment and a second segment which inserts through the through orifice of the base and the through hole of the gear disc.

The rotation disc is fitted with the second segment of the rotary knob.

The gear disc also includes a protruded stem adjacent to the through hole; and the rotary knob also includes a driving block arranged on the second segment thereof and corresponding to the protruded stem.

In operation, the power assembly drives the gear disc to rotate, and the protruded stem of the gear disc drives the driving block of the rotary knob to revolve so that the rotary knob is rotated with the driving block to open and close the electronic lock easily and stably.

### BRIEF DESCRIPTION OF THE DRAWINGS

FIG. 1 is a side plan view showing the exploded components of a conventional electronic lock.

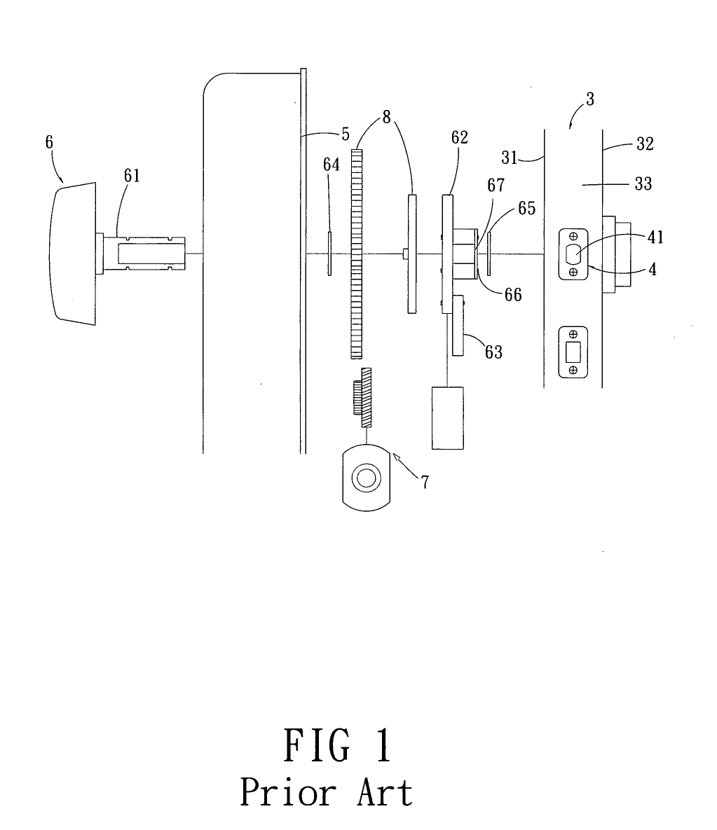

FIG. 2 is a cross sectional view showing the assembly of the conventional electronic lock.

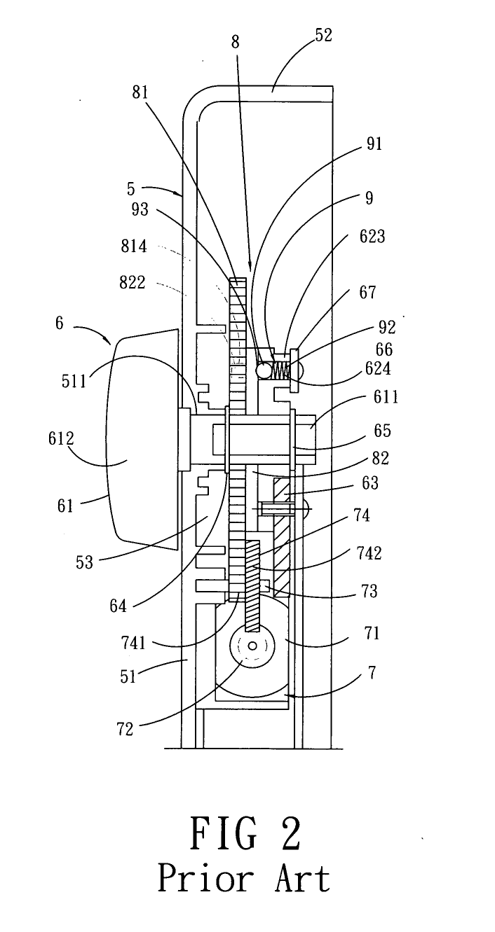

FIG. 3 is a perspective view showing the exploded components of a driving device of an electronic lock according to a preferred embodiment of the present invention.

FIG. 4 is a plan view showing the operation of the driving device of the electronic clock according to the preferred embodiment of the present invention.

FIG. 5 is a cross sectional view taken along the line A-A of FIG. 4.

### DETAILED DESCRIPTION OF THE PREFERRED EMBODIMENTS

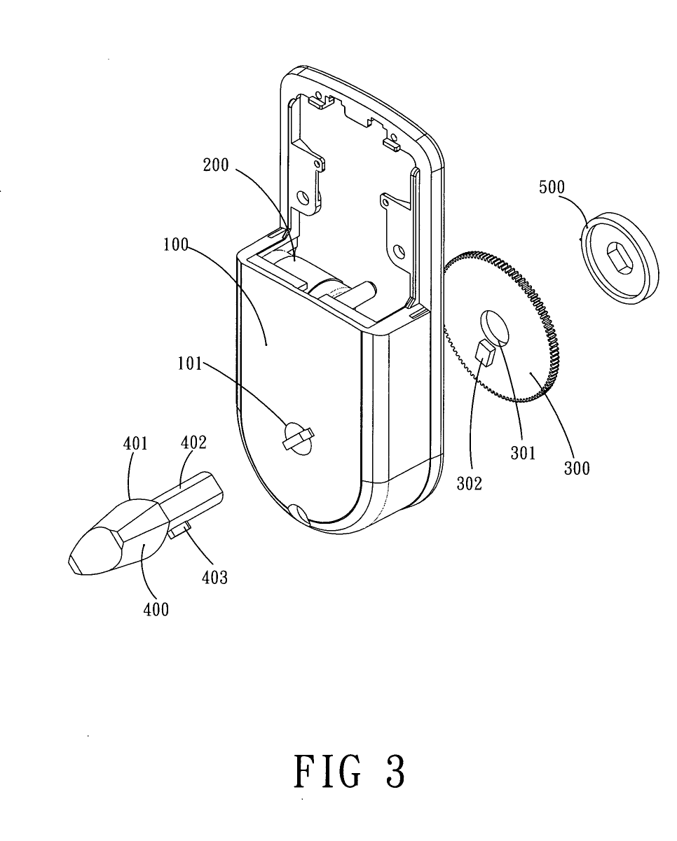

With reference to FIGS. 3 to 5, a driving device of an electronic lock according to a preferred embodiment of the present invention, wherein the electronic lock is mounted on a door, and the driving device comprises: a base 100, a power assembly 200, a gear disc 300, a rotary knob 400, and a rotation disc 500. The base 100 is a casing and includes a through orifice 101 defined thereon to insert the rotary knob 400 and includes an accommodation chamber formed therein to accommodate the power assembly 200. The power assembly 200 supplies a power source to rotate the gear disc 300. The gear disc 300 includes a through hole 301 defined on a central position thereof and corresponding to the through orifice 101 of the base 100, and the gear disc 300 also includes a protruded stem 302 adjacent to the through hole 301. The rotary knob 400 includes a first segment 401 and a second segment 402 which inserts through the through orifice 101 of the base 100 and the through hole 301 of the gear disc 300, and the rotary knob 400 also includes a driving block 403 arranged on the second segment 402 thereof and corresponding to the protruded stem 302. The rotation disc 500 is fitted with the second segment 402 of the rotary knob 400.

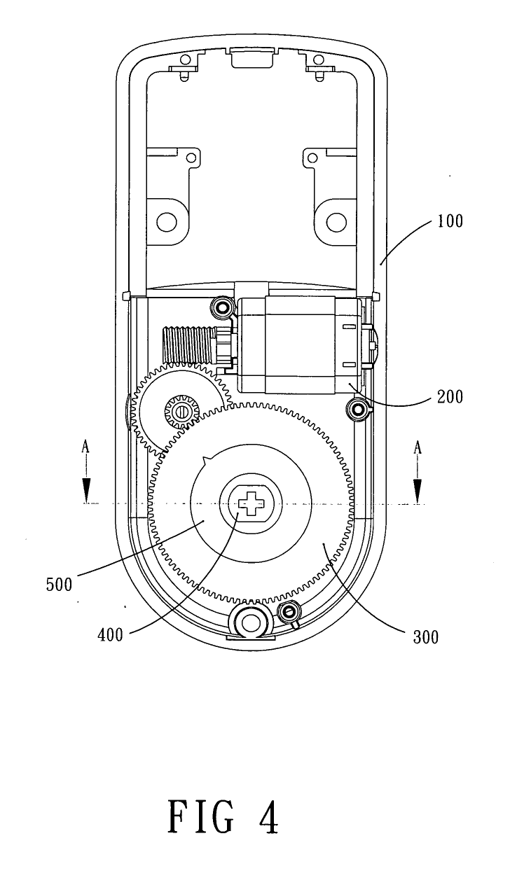

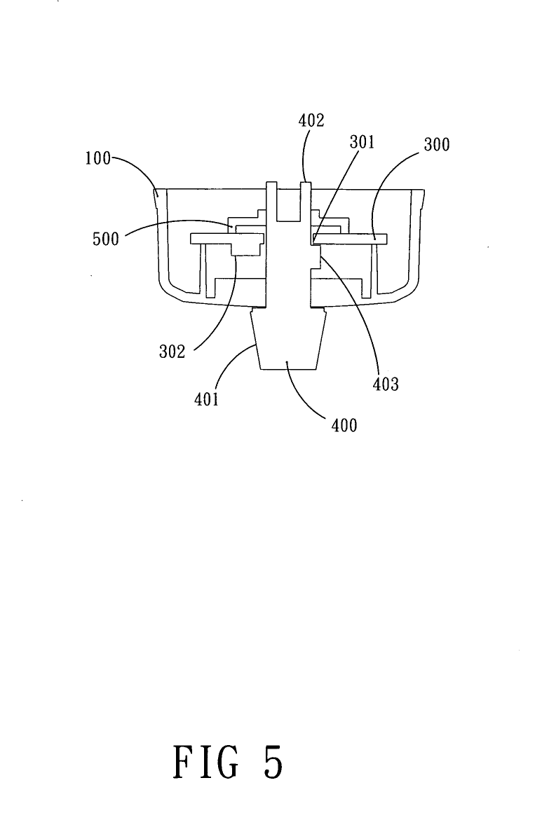

In operation, as illustrated in FIGS. 4 and 5, the power assembly 200 drives the gear disc 300 to rotate, and the protruded stem 302 of the gear disc 300 drives the driving block 403 of the rotary knob 400 to revolve so that the rotary knob 400 is rotated with the driving block 403 to open and close the electronic lock easily and stably.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A driving device of an electronic lock comprising: a base, a power assembly, a gear disc, a rotary knob, and a rotation disc;
the base being a casing and including a through orifice defined thereon to insert the rotary knob, and the base also including an accommodation chamber formed therein to accommodate the power assembly;
the power assembly supplying a power source to rotate the gear disc;
the gear disc including a through hole defined on a central position thereof and corresponding to the through orifice of the base;
the rotary knob including a first segment and a second segment which inserts through the through orifice of the base and the through hole of the gear disc;
the rotation disc being fitted with the second segment of the rotary knob; wherein
the gear disc also includes a protruded stem adjacent to the through hole; and
the rotary knob also includes a driving block arranged on the second segment thereof and corresponding to the protruded stem.
